(19) United States
(12) Patent Application Publication
(10) Pub. No.: US 2024/0218133 A1
(43) Pub. Date: Jul. 4, 2024

(54) GRAPHENE QUANTUM DOT/POLYMER ANTIBACTERIAL AND ANTIVIRAL COMPOSITE FIBER AND PREPARATION METHOD THEREFOR

(71) Applicant: Qingdao University, Qingdao (CN)

(72) Inventors: Lijun Qu, Qingdao (CN); Xili Hu, Qingdao (CN); Hongtao Zhao, Jining (CN)

(21) Appl. No.: 18/335,144

(22) Filed: Jun. 15, 2023

(30) Foreign Application Priority Data
Jul. 26, 2022 (CN) 2022108824201

(51) Int. Cl. C08J 5/00; C08J 3/22; C08K 3/04

(52) U.S. Cl. CPC C08J 5/005; C08J 3/22; C08K 3/042; C08J 2333/20; C08J 2367/00; C08J 2377/00; C08K 2201/003; C08K 2201/011

(57) ABSTRACT

A graphene quantum dot/polymer antibacterial and antiviral composite fiber and a preparation method therefor are provided. The graphene quantum dot/polymer antibacterial and antiviral composite fiber is prepared by melt spinning, solving problems that graphene quantum dots are easy to agglomerate and difficult to be effectively oriented. In addition, the composite fiber has excellent antibacterial and antibacterial properties, as well as good mechanical properties, environmental friendliness, a silky and smooth feel, a plump and glutinous cashmere, fluffy, good rebound, comfortable touch, and good wearing performance. Furthermore, according to different addition amounts of the graphene quantum dots, the graphene quantum dots have various colors, such as original white, light tea color or light coffee color, which breaks through an inherent color limitation of traditional graphene modified fibers in black and gray.

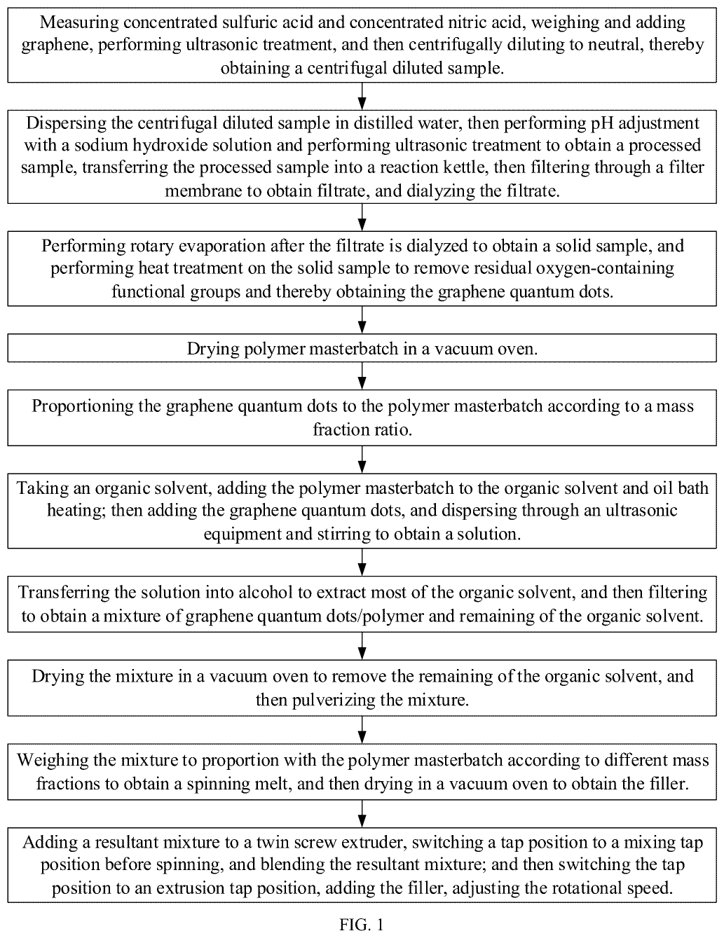

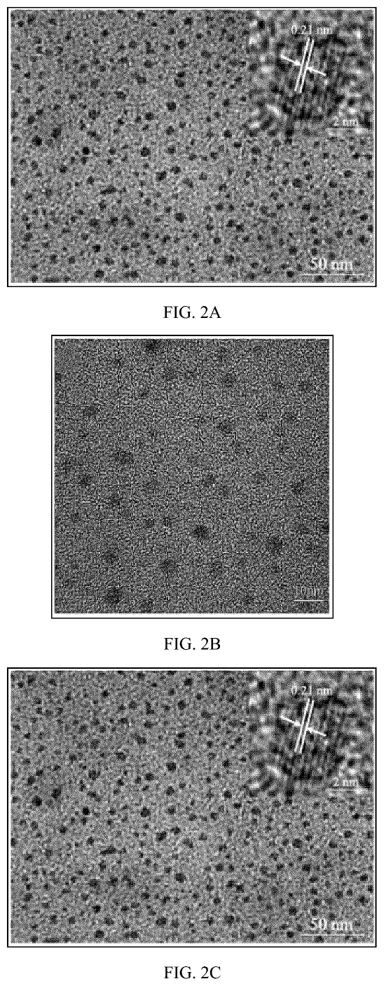

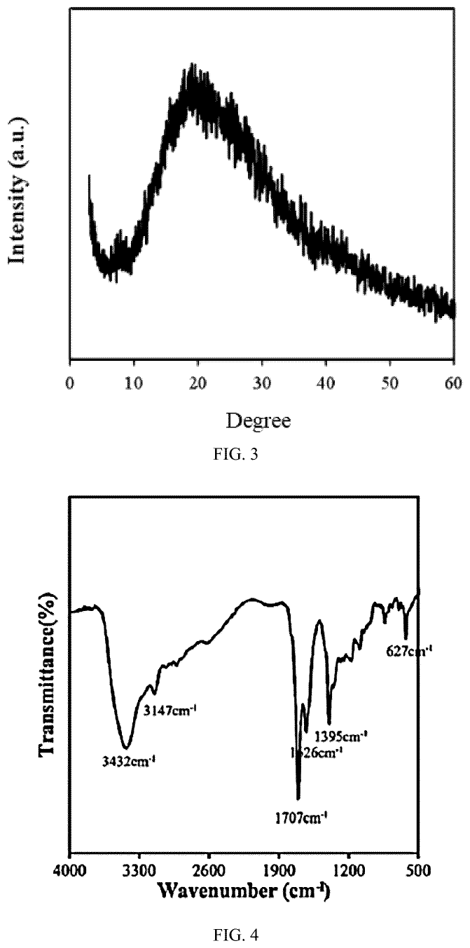

### TECHNICAL FIELD

The disclosure relates to the field of composite fiber technology, particularly to a graphene quantum dot/polymer antibacterial and antiviral composite fiber and a preparation method therefor.

### BACKGROUND

Graphene quantum dots (GQDs) belong to a kind of novel carbon nanomaterial. Current studies suggest that graphene with transverse dimensions within 100 nm and a thickness of several nanometers may be called the graphene quantum dot. The graphene quantum dots, as a quasi-zero-dimensional nanomaterial of carbon quantum dots, not only have all advantages of the carbon quantum dots, such as chemical inertness, low toxicity, good biocompatibility, anti-photobleaching, and size-wavelength dependent photoluminescence, but also have the unique structure and excellent characteristics of the graphene, such as an ultra-high specific surface area and excellent conductivity. In addition, since the dimensions of the graphene quantum dot each are nanoscale, it is affected by the quantum confinement effect and the size effect, thus possessing an adjustable bandgap that varies with size. The graphene quantum dots are promising for an application in nano-sensing, electrode materials, photocatalysis, functional composite materials, and the like because they have some properties of the graphene as well as the carbon quantum dots.

Preparation methods for graphene quantum dots can be roughly classified into two types from the perspective of preparation path, i.e., a top-bottom method and a bottom-up method. The top-bottom method is using a physical method to cut a large-size material with a graphene structure having a sp² structure, such as graphite, graphene oxide, carbon nanotubes, and fullerenes. This kind of method includes an electrochemical method, an oxidation cutting method, a microwave-assisted oxidation method, a chemical stripping method, a hydrothermal synthesis method, an oxygen plasma cutting method, an ultrasonic method, a solvothermal method, and the like. However, the above methods generally involve processes such as strong acid, strong oxidant treatment, and high-temperature and high-pressure. Although the processes are relatively simple and the yield of the graphene quantum dots is relatively high, the graphene quantum dots prepared by these methods are often not uniform in size and have excessive defects. The bottom-up method refers to a process of preparing graphene quantum dots by using small molecules as carbon source materials through a series of chemical reactions, including carbonization of carbohydrates, self-assembling of polycyclic aromatic hydrocarbons, and organic synthesis of non-aromatic small molecules. The bottom-up method has good controllability, and the obtained graphene quantum dots are relatively excellent in size, morphology, and properties. However, the existing preparation methods of graphene quantum dots have low yields, which limit applications of the graphene quantum dots, and therefore, it is urgently needed to provide a high-efficiency, high-quality, and high-yield preparation method for graphene quantum dots.

Since the graphene quantum dots are obtained by cutting a large-size graphene, the particle size of the graphene quantum dot is smaller, thereby making the graphene quantum dots have a larger specific surface area than the graphene. Moreover, since the graphene quantum dots are different from the most common graphene and graphene oxide, the graphene quantum dots have a characteristic of efficiently converting light energy into heat energy, and also have a characteristic of generating reactive oxygen species (ROS). However, excessive ROS can destroy cell membranes, proteins, and deoxyribonucleic acid (DNA) and thereby kill cells. Thus, the graphene quantum dots belong to a sterilization material with excellent performance and good application prospects. Furthermore, the graphene quantum dots belong to inorganic nonmetal antibacterial materials, and are superior to current silver ions and quaternary ammonium salt antibacterial fibers. Therefore, the research and development and industrialization of inorganic nonmetal-graphene quantum dot antibacterial composite fibers can fundamentally break through export bans on metal-based antibacterial fibers with silver ions. The graphene quantum dots are regarded as a carbon nanomaterial with a rigid sheet-like structure similar to graphene, and if the graphene quantum dots can be covalently connected with a polymer to form a polymer composite material, the regularity of fiber structure and homogenization degree of radial structure can be greatly enhanced, so that performance of the composite fiber is further improved. However, a preparation of an antibacterial and bacteriostatic composite fiber based on graphene quantum dots still has problems such as easy aggregation of the graphene quantum dots, difficulty in effective orientation, and difficulty in realizing multi-scale structure regulation, which increases the difficulty of preparing the organic-inorganic hybrid antibacterial fiber.

The textile industry is an important livelihood industry and a pillar industry of the national economy in China. With the development of the economy and the improvement of living standards, the connotation of the textile industry has undergone a qualitative leap, “high-tech, green, and fashion” are becoming new labels of the industry, and the development of the textile industry has also shifted from traditional textiles to advanced textiles with integrated functions. Therefore, developing the preparation of inorganic nonmetal-graphene quantum dot/polymer antibacterial composite fiber, its industrialization engineering, and combining an advanced graphene quantum dots based new material with the advanced textile technology, would have important significance and good market prospect for the research and development of textile materials with integrated functions.

### SUMMARY

In view of the deficiencies in the related art, the disclosure provides a graphene quantum dot/polymer antibacterial and antiviral composite fiber and its preparation method, which solve the problems that graphene quantum dots are easy to agglomerate and difficult to be effectively oriented. The prepared composite fiber has excellent antibacterial and bacteriostatic properties and well mechanical properties, and is environmentally friendly, smooth in-hand feel, plump, smooth, glutinous, fluffy, good in resilience, comfortable to touch, and good in wearability. According to different addition amounts of the graphene quantum dots, colors of the graphene quantum dots are classified in various colors, such as original white, light tea color, or light coffee color, which breaks through an inherent color limitation of the traditional graphene-modified fiber in black and gray. Moreover, the graphene quantum dots belong to an inorganic nonmetal antibacterial material, and therefore the development of the graphene quantum dot/polymer antibacterial and antiviral composite fiber can break through export bans released by Europe and the United States on metal-based antibacterial fibers with silver ions.

To solve the above problems, the technical solutions of the disclosure are a graphene quantum dot/polymer antibacterial and antiviral composite fiber and a preparation method therefor. The graphene quantum dot/polymer antibacterial and antiviral composite fiber is prepared by a melt spinning through a mixture and a filler. The mixture is configured for melting, including graphene quantum dots and a polymer prepared from a polymer masterbatch, and the filler includes the mixture and a polymer masterbatch.

In the graphene quantum dot/polymer antibacterial and antiviral composite fiber, a mass fraction ratio of the graphene quantum dots to the polymer masterbatch is 1: 10-20.

In the graphene quantum dot/polymer antibacterial and antiviral composite fiber, a solid content of the graphene quantum dots in the filler is in a range of 0.1% to 1%.

In the graphene quantum dot/polymer antibacterial and antiviral composite fiber, a size of each of the graphene quantum dots is in a range of 10 nanometers (nm) to 8000 nm.

In the graphene quantum dot/polymer antibacterial and antiviral composite fiber, the polymer masterbatch is one or more selected from the group consisting of a polyamide masterbatch, a polyester masterbatch, and a polyacrylonitrile masterbatch.

In the graphene quantum dot/polymer antibacterial and antiviral composite fiber, a diameter of the graphene quantum dot/polymer antibacterial and antiviral composite fiber is in a range of 20 micrometers (μm) to 500 μm.

The preparation method for the graphene quantum dot/polymer antibacterial and antiviral composite fiber includes the following steps:
step 1, individually measuring 10 milliliters (mL) to 30 mL of concentrated sulfuric acid and 50 mL to 70 mL of concentrated nitric acid and then uniformly mixing to obtain a strong acid mixed solution, weighing 80 milligrams (mg) to 120 mg of graphene and adding into the strong acid mixed solution, performing ultrasonic treatment on the strong acid mixed solution with the graphene for 12 hours (h) to 18 h, and then centrifugally diluting to neutral at a speed of 7000 revolutions per minute (r/min) after the ultrasonic treatment, thereby obtaining a centrifugal diluted sample;
step 2, dispersing the centrifugal diluted sample in 50 mL to 70 mL of distilled water, then performing pH adjustment to a pH value of 8 with a sodium hydroxide solution and performing ultrasonic treatment for 1 h to 3 h to obtain a processed sample, transferring the processed sample into a reaction kettle for treatment at 200 degrees Celsius (° C.) for 10 h, then filtering through a filter membrane with a pore size of 0.22 μm after the processed sample is cooled down to room temperature to obtain filtrate, and dialyzing the filtrate for 1 to 3 days;
step 3, performing rotary evaporation after the filtrate is dialyzed to obtain a solid sample, and performing heat treatment on the solid sample to remove residual oxygen-containing functional groups and thereby obtaining the graphene quantum dots;
step 4, drying the polymer masterbatch in a vacuum oven at 60° C. to 100° C. for 6 h to 10 h;
step 5, proportioning the graphene quantum dots to the polymer masterbatch after the drying according to a mass fraction ratio of 1:10-20;
step 6, taking an organic solvent, adding the polymer masterbatch after the proportioning to the organic solvent and oil bath heating to 110° C. to 150° C.; then adding the graphene quantum dots after the proportioning, and dispersing through a piece of ultrasonic equipment for 0.5 h to 1.5 h and stirring until the graphene quantum dots are completely dissolved to obtain a solution;
step 7, transferring the solution obtained in the step 6 into alcohol to extract most of the organic solvent in the solution, and then filtering to obtain a mixture of graphene quantum dots/polymer and remaining of the organic solvent;
step 8, drying the mixture obtained in the step 7 in a vacuum oven at 60° C. to 100° ° C. for 36 h to 60 h to remove the remaining of the organic solvent, and then pulverizing the mixture after the drying for subsequent spinning;
step 9, weighing the mixture obtained in the step 7 to proportion with the polymer masterbatch according to different mass fractions to obtain a spinning melt with a solid content of graphene quantum dot in a range of 0.1% to 1%, and then drying in a vacuum oven at a temperature of 60° ° C. to 100° C. for 6 h to 10 h to obtain the filler for the subsequent spinning;
step 10, using a twin screw extruder and a winder as equipment for the spinning, adding a resultant mixture obtained in the step 8 to the twin screw extruder, switching a tap position of the twin screw extruder to a mixing tap position before the spinning, and blending the resultant mixture in the twin screw extruder at a rotational speed of 30 rpm to 40 rpm for 5 min to 10 min; and then switching the tap position of the twin screw extruder to an extrusion tap position, adding the filler, adjusting the rotational speed to 10 rpm to 20 rpm, and perform the spinning. Furthermore, a heating temperature setting of the twin screw extruder is as follows: a first zone is at 180° ° C. to 200° ° C., a second zone is at 200° ° C. to 220° C., and a third zone is at 180° ° C. to 220° C.; and a winding speed of the winder is in a range of 80 meters per minute (m/min) to 120 m/min.

In the preparation method for the graphene quantum dot/polymer antibacterial and antiviral composite fiber, the organic solvent is xylene, and a mass fraction ratio of the polymer masterbatch to the xylene is 1:1-10.

The graphene quantum dot/polymer antibacterial and antiviral composite fiber and the preparation method therefor have beneficial effects. The mixture composed of the graphene quantum dots and the polymer is prepared first, then the filler composed of the mixture and the polymer masterbatch is prepared, thereby solving the problem that the graphene quantum dots are easy to agglomerate and are difficult to orient effectively. In addition, the disclosure uses the graphene quantum dots to develop antibacterial and bacteriostatic fibers to solve the problem of existing antibacterial fibers mainly containing silver ions and quaternary ammonium salts, and to develop inorganic nonmetal-graphene quantum dot antibacterial composite fibers, thereby fundamentally breaking through the export bans released by Europe and the United States on the metal-based antibacterial fibers with silver ions.

Antibacterial and bacteriostatic properties of the graphene quantum dot/polymer antibacterial and antiviral composite fiber are superior to those of the current antibacterial fibers with silver ions and quaternary ammonium salts.

Especially, first, the graphene quantum dot/polyamide composite fiber with excellent antibacterial and bacteriostatic properties is prepared, antibacterial rates for bacterium coli, Staphylococcus aureus, and Candida albicans are individually greater than or equal to 99%, an inactivation rate of influenza A virus H1N1(A/PR/8/34) reaches 99%, and an inactivation rate for enterovirus 71 reaches 99%.

Second, a water washing fastness and a soaping fastness of the prepared graphene quantum dot/polyamide antibacterial composite fiber reach above class four.

Third, the strength of the graphene quantum dots/polyamide antibacterial composite fiber is increased by 10% to 30% compared with conventional polyamide fibers (chinlone filaments with 70 D and staple fibers with 1.2 D).

Fourth, the graphene quantum dots are added to serve as an antibacterial agent by means of blending, effectively preventing the antibacterial agent from falling off to make the antibacterial effect more durable. In addition, compared with a traditional silver-based antibacterial agent, the graphene quantum dots kill microorganisms through photo-thermal and generated reactive oxygen species, thereby realizing better biological safety.

Fifth, the disclosure is environmentally friendly, comfortable to touch, and good in wearability. In addition, according to different addition amounts of the graphene quantum dots, graphene quantum dots have various colors, such as original white, light tea color, or light coffee color, realizing breaking through the inherent color limitation of the traditional graphene-modified fibers in black and gray.

Sixth, the preparation method for the graphene quantum dots is high in efficiency, quality, and yield and the size of the graphene quantum dot is in a range of 10 nm to 8000 nm.

### DETAILED DESCRIPTION OF EMBODIMENTS

The disclosure is further described below in combination with illustrated embodiments.

### Embodiment 1

A graphene quantum dot/polymer antibacterial and antiviral composite fiber and a preparation method therefor are provided. The composite fiber is prepared by a melt spinning through a mixture and a filler. The mixture is used for melting, including graphene quantum dots and a polymer prepared from a polymer masterbatch, and the filler includes a certain amount of the mixture and a polymer masterbatch.

A mass fraction ratio of the graphene quantum dots to the polymer masterbatch is 1:10.

A solid content of the graphene quantum dots in the filler is 0.1%.

A size of each of the graphene quantum dots is 10 nm.

The polymer masterbatch is one or more selected from the group consisting of a polyamide masterbatch, a polyester masterbatch, and a polyacrylonitrile masterbatch.

A diameter of the graphene quantum dot/polymer antibacterial and antiviral composite fiber is 20 μm.

The preparation method for the graphene quantum dot/polymer antibacterial and antiviral composite fiber includes the following steps.

Step 1, 10 milliliters (mL) of concentrated sulfuric acid and 50 mL of concentrated nitric acid are individually measured, then uniformly mixed to obtain a strong acid mixed solution; 80 milligrams (mg) of graphene are weighed and then added into the strong acid mixed solution; ultrasonic treatment is performed on the strong acid mixed solution with the graphene for 12 h, followed by being centrifugally diluted to neutral at a speed of 7000 revolutions per minute (r/min) after the ultrasonic treatment, thereby obtaining a centrifugal diluted sample.

Step 2, the centrifugal diluted sample is dispersed in 50 mL of distilled water, pH adjustment is performed on the centrifugal diluted sample dissolved in the distilled water to a pH value of 8 with a sodium hydroxide solution, followed by performing ultrasonic treatment for 1 h to obtain a processed sample; the processed sample is transferred into a reaction kettle at 200 degrees Celsius (° C.) for 10 h, followed by filtering through a filter membrane with a pore size of 0.22 μm after the processed sample is cooled down to room temperature to obtain filtrate; and the filtrate is dialyzed for 1 day.

Step 3, a solid sample is obtained by performing rotary evaporation after the filtrate is dialyzed; and heat treatment is performed on the solid sample to remove residual oxygen-containing functional groups and thereby obtain the graphene quantum dots.

Step 4, the polymer masterbatch is dried in a vacuum oven at 60° ° C. for 6 h for later use.

Step 5, the graphene quantum dots and the polymer masterbatch are proportioned after the drying according to a mass fraction ratio of 1:10.

Step 6, an organic solvent is taken as a solvent, and the polymer masterbatch is added to the organic solvent after the proportioning, followed by oil bath heating to 110° C.; then the graphene quantum dots after the proportioning are added to be dispersed through a piece of ultrasonic equipment for 0.5 h until the graphene quantum dots are completely dissolved by stirring to obtain a solution.

Step 7, the solution obtained in the step 6 is transferred into excessive alcohol to extract most of the organic solvent in the solution; then the solution is filtered to obtain a mixture of graphene quantum dots/polymer and remaining of the organic solvent.

Step 8, the mixture obtained in the step 7 is dried in a vacuum oven at 60° C. for 36 h to remove the remaining of the organic solvent; and then the mixture is pulverized after the drying for subsequent spinning.

Step 9, the mixture obtained in the step 7 is weighed to proportion with the polymer masterbatch according to different mass fractions to obtain a spinning melt with a solid content of graphene quantum dot in a range of 0.1%; then the spinning is dried in a vacuum oven at a temperature of 60ºC for 6 h to obtain the filler for the subsequent spinning.

Step 10, a twin-screw extruder and a winder are used as equipment for the spinning, a resultant mixture obtained in the step 8 is added to the extruder and a tap position of the extruder is switched to a mixing tap position before the spinning; and then the resultant mixture is blended in the extruder at a rotational speed of 30 rpm for 5 min; then the tap position of the extruder is switched to an extrusion tap position, then the filler is added into the extruder while adjusting the rotational speed to 10 rpm to perform the spinning. In the embodiment, a heating temperature setting is as follows: a first zone is at 180ºC, a second zone is at 200° C., and a third zone is at 180ºC. Furthermore, a winding speed of the winder is 80 meters per minute (m/min).

In the preparation method for the graphene quantum dot/polymer antibacterial and antiviral composite fiber of the embodiment 1, the organic solvent is xylene, and a mass fraction ratio of the polymer masterbatch to the xylene is 1:1.

### Embodiment 2

The same part of the embodiment 2 as the embodiment 1 will not be repeated, except that the followings.

A mass fraction ratio of the graphene quantum dots to the polymer masterbatch is 1:15.

A solid content of the graphene quantum dots in the filler is 0.5%.

A size of each of the graphene quantum dots is 500 nm.

The polymer masterbatch is one or more selected from the group consisting of a polyamide masterbatch, a polyester masterbatch, and a polyacrylonitrile masterbatch.

A diameter of the graphene quantum dot/polymer antibacterial and antiviral composite fiber is 100 μm.

The preparation method for the graphene quantum dot/polymer antibacterial and antiviral composite fiber includes following steps.

Step 1, 20 mL of concentrated sulfuric acid and 60 mL of concentrated nitric acid are individually measured to uniformly mix to obtain a strong acid mixed solution; 100 mg of graphene are weighed and then added into the strong acid mixed solution; ultrasonic treatment is performed on the strong acid mixed solution with the graphene for 15 h, followed by being centrifugally diluted to neutral at a speed of 7000 r/min after the ultrasonic treatment, thereby obtaining a centrifugal diluted sample.

Step 2, the centrifugal diluted sample is dispersed in 60 mL of distilled water, pH adjustment is performed on the centrifugal diluted sample dissolved in the distilled water to a pH value of 8 with a sodium hydroxide solution, followed by performing ultrasonic treatment for 2 h to obtain a processed sample; the processed sample is transferred into a reaction kettle at 200° ° C. for 10 h, followed by filtering through a filter membrane with a pore size of 0.22 μm after the processed sample is cooled down to room temperature to obtain filtrate; and the filtrate is dialyzed for 2 days.

Step 3, a solid sample is obtained by performing rotary evaporation after the filtrate is dialyzed; and heat treatment is performed on the solid sample to remove residual oxygen-containing functional groups and thereby obtaining the graphene quantum dots.

Step 4, the polymer masterbatch is dried in a vacuum oven at 80° C. for 8 h for later use.

Step 5, the graphene quantum dots and the polymer masterbatch are proportioned after the drying according to a mass fraction ratio of 1:15.

Step 6, an organic solvent is taken as a solvent, the polymer masterbatch is added to the organic solvent after the proportioning, followed by oil bath heating to 130° C.; then the graphene quantum dots after the proportioning are added to be dispersed through an ultrasonic equipment for 1 h until the graphene quantum dots are completely dissolved by stirring to obtain a solution.

Step 7, the solution obtained in the step 6 is transferred into excessive alcohol to extract most of the organic solvent in the solution; and then the solution is filtered to obtain a mixture of graphene quantum dots/polymer and remaining of the organic solvent.

Step 8, the mixture obtained in the step 7 is dried in a vacuum oven at 80° C. for 48 h to remove the remaining of the organic solvent; and then the mixture is pulverized after the drying for subsequent spinning.

Step 9, the mixture obtained in the step 7 is weighed to proportion with the polymer masterbatch according to different mass fractions to obtain a spinning melt with a solid content of graphene quantum dot in a range of 0.5%; and then the spinning is dried in a vacuum oven at a temperature of 80° C. for 8 h to obtain the filler for the subsequent spinning.

Step 10, a twin-screw extruder and a winder are used as equipment for the spinning, a resultant mixture obtained in the step 8 is added to the extruder and a tap position of the extruder is switched to a mixing tap position before the spinning; and then the resultant mixture is blended in the extruder at a rotational speed of 35 rpm for 8 min; then the tap position of the extruder is switched to an extrusion tap position, and then the filler is added into the extruder while adjusting the rotational speed to 15 rpm to perform the spinning. In the embodiment, a heating temperature setting is as follows: a first zone is at 190° C., a second zone is at 210° C., and a third zone is at 200° C. Furthermore, a winding speed of the winder is 100 m/min.

In the preparation method for the graphene quantum dot/polymer antibacterial and antiviral composite fiber of the embodiment 2, the organic solvent is xylene, and a mass fraction ratio of the polymer masterbatch to the xylene is 1:5.

### Embodiment 3

The same part of the embodiment 3 as the embodiment 1 will not be repeated, except that the followings.

A mass fraction ratio of the graphene quantum dots to the polymer masterbatch is 1:20.

A solid content of the graphene quantum dots in the filler is 1%.

A size of each of the graphene quantum dots is 8000 nm.

The polymer masterbatch is one or more selected from the group consisting of a polyamide masterbatch, a polyester masterbatch, and a polyacrylonitrile masterbatch.

A diameter of the graphene quantum dot/polymer antibacterial and antiviral composite fiber is 500 μm.

The preparation method for the graphene quantum dot/polymer antibacterial and antiviral composite fiber includes following steps.

Step 1, 30 mL of concentrated sulfuric acid and 70 mL of concentrated nitric acid are individually measured to uniformly mix to obtain a strong acid mixed solution; 120 mg of graphene are weighed and then added into the strong acid mixed solution; ultrasonic treatment is performed on the strong acid mixed solution with the graphene for 18 h, followed by being centrifugally diluted to neutral at a speed of 7000 r/min after the ultrasonic treatment, thereby obtaining a centrifugal diluted sample.

Step 2, the centrifugal diluted sample is dispersed in 70 mL of distilled water, pH adjustment is performed on the centrifugal diluted sample dissolved in the distilled water to a pH value of 8 with a sodium hydroxide solution, followed by performing ultrasonic treatment for 3 h to obtain a processed sample; the processed sample is transferred into a reaction kettle at 200° ° C. for 10 h, followed by filtering through a filter membrane with a pore size of 0.22 μm after the processed sample is cooled down to room temperature to obtain filtrate; and the filtrate is dialyzed for 3 days.

Step 3, a solid sample is obtained by performing rotary evaporation after the filtrate is dialyzed; and heat treatment is performed on the solid sample to remove residual oxygen-containing functional groups and thereby obtaining the graphene quantum dots.

Step 4, the polymer masterbatch is dried in a vacuum oven at 100° C. for 10 h for later use.

Step 5, the graphene quantum dots and the polymer masterbatch are proportioned after the drying according to a mass fraction ratio of 1:20.

Step 6, an organic solvent is taken as a solvent, the polymer masterbatch is added to the organic solvent after the proportioning, followed by oil bath heating to 150° C.; then the graphene quantum dots after the proportioning are added to be dispersed through an ultrasonic equipment for 1.5 h until the graphene quantum dots are completely dissolved by stirring to obtain a solution.

Step 7, the solution obtained in the step 6 is transferred into a large amount of alcohol to extract most of the organic solvent in the solution; and then the solution is filtered to obtain a mixture of graphene quantum dots/polymer and remaining of the organic solvent.

Step 8, the mixture obtained in the step 7 is dried in a vacuum oven at 100° C. for 60 h to remove the remaining of the organic solvent; and then the mixture is pulverized after the drying for subsequent spinning.

Step 9, the mixture obtained in the step 7 is weighed to proportion with the polymer masterbatch according to different mass fractions to obtain a spinning melt with a solid content of graphene quantum dot in a range of 1%; and then the spinning is dried in a vacuum oven at a temperature of 100° C. for 10 h to obtain the filler for the subsequent spinning.

Step 10, a twin-screw extruder and a winder are used as equipment for the spinning, a resultant mixture obtained in the step 8 is added to the extruder and a tap position of the extruder is switched to a mixing tap position before the spinning; and then the resultant mixture is blended in the extruder at a rotational speed of 40 rpm for 10 min; then the tap position of the extruder is switched to an extrusion tap position, and then the filler is added into the extruder while adjusting the rotational speed to 20 rpm to perform the spinning. In the embodiment, a heating temperature setting is as follows: a first zone is at 200° C., a second zone is at 220° C., and a third zone is at 220° C. Furthermore, a winding speed of the winder is 120 m/min.

In the preparation method for the graphene quantum dot/polymer antibacterial and antiviral composite fiber of the embodiment 3, the organic solvent is xylene, and a mass fraction ratio of the polymer masterbatch to the xylene is 1:10.

Aiming at the export bans released by Europe and the United States of using the nano-silver in the antibacterial textile industry, the developed graphene quantum dot/polymer composite fiber has excellent antibacterial and bacteriostatic properties based on the excellent antibacterial property of the inorganic nonmetal-graphene quantum dots and the excellent characteristics of the polymer fiber, and is superior to the existing antibacterial fibers with silver ions and the antibacterial fibers with quaternary ammonium salt. Therefore, the research and development and industrialization of the inorganic nonmetal-graphene quantum dot/polymer antibacterial composite fiber fundamentally break through the export bans released by Europe and the United States on the metal-based antibacterial fiber with silver ions. Meanwhile, the graphene quantum dot/polymer composite fiber has excellent washing resistance and soaping stability and it is environmentally friendly, comfortable to touch, and good in wearability. In addition, the graphene quantum dot/polymer antibacterial composite fiber developed by the disclosure is more colorful, and the inherent black gray color limitation of the traditional graphene modified fiber is broken through.

In addition, the above description is not a limitation on the disclosure, and the disclosure is not limited to the above embodiments. In addition, changes, modifications, additions or substitutions made by those skilled in the related art within the essential scope of the disclosure also fall within the protection scope of the disclosure.

What is claimed is:

1. A graphene quantum dot/polymer antibacterial and antiviral composite fiber prepared by a melt spinning through a mixture and a filler, wherein the mixture is configured for melting and comprises graphene quantum dots and a polymer prepared from a polymer masterbatch, and the filler comprises the mixture and a polymer masterbatch.

2. The graphene quantum dot/polymer antibacterial and antiviral composite fiber according to claim 1, wherein a mass fraction ratio of the graphene quantum dots to the polymer masterbatch is 1: 10-20.

3. The graphene quantum dot/polymer antibacterial and antiviral composite fiber according to claim 2, wherein a solid content of the graphene quantum dots in the filler is in a range of 0.1% to 1%.

4. The graphene quantum dot/polymer antibacterial and antiviral composite fiber according to claim 3, wherein a size of each of the graphene quantum dots is in a range of 10 nanometers (nm) to 8000 nm.

5. The graphene quantum dot/polymer antibacterial and antiviral composite fiber according to claim 4, wherein the polymer masterbatch is one or more selected from the group consisting of a polyamide masterbatch, a polyester masterbatch, and a polyacrylonitrile masterbatch.

6. The graphene quantum dot/polymer antibacterial and antiviral composite fiber according to claim 5, wherein a diameter of the graphene quantum dot/polymer antibacterial and antiviral composite fiber is in a range of 20 micrometers (μm) to 500 μm.

7. A preparation method for the graphene quantum dot/polymer antibacterial and antiviral composite fiber according to claim 1, comprising:
step 1, individually measuring 10 milliliters (mL) to 30 mL of concentrated sulfuric acid and 50 mL to 70 mL of concentrated nitric acid and then uniformly mixing to obtain a strong acid mixed solution, weighing 80 milligrams (mg) to 120 mg of graphene and adding into the strong acid mixed solution, performing ultrasonic treatment on the strong acid mixed solution with the graphene for 12 hours (h) to 18 h, and then centrifugally diluting to neutral at a speed of 7000 revolutions per minute (r/min) after the ultrasonic treatment, thereby obtaining a centrifugal diluted sample;
step 2, dispersing the centrifugal diluted sample in 50 mL to 70 mL of distilled water, then performing pH adjustment to a pH value of 8 with a sodium hydroxide solution and performing ultrasonic treatment for 1 h to 3 h to obtain a processed sample, transferring the processed sample into a reaction kettle for treatment at 200 degrees Celsius (° C.) for 10 h, then filtering through a filter membrane with a pore size of 0.22 μm after the processed sample is cooled down to room temperature to obtain filtrate, and dialyzing the filtrate for 1 day to 3 days;
step 3, performing rotary evaporation after the filtrate is dialyzed to obtain a solid sample, and performing heat treatment on the solid sample to remove residual oxygen-containing functional groups and thereby obtaining the graphene quantum dots;
step 4, drying the polymer masterbatch in a vacuum oven at 60° C. to 100° ° C. for 6 h to 10 h;
step 5, proportioning the graphene quantum dots to the polymer masterbatch after the drying according to a mass fraction ratio of 1:10-20;
step 6, taking an organic solvent, adding the polymer masterbatch after the proportioning to the organic solvent and oil bath heating to 110° ° C. to 150° C.; then adding the graphene quantum dots after the proportioning, and dispersing through an ultrasonic equipment for 0.5 h to 1.5 h and stirring until the graphene quantum dots are completely dissolved to obtain a solution;
step 7, transferring the solution obtained in the step 6 into alcohol to extract most of the organic solvent in the solution, and then filtering to obtain a mixture of graphene quantum dots/polymer and remaining of the organic solvent;
step 8, drying the mixture obtained in the step 7 in a vacuum oven at 60° C. to 100° C. for 36 h to 60 h to remove the remaining of the organic solvent, and then pulverizing the mixture after the drying for subsequent spinning;
step 9, weighing the mixture obtained in the step 7 to proportion with the polymer masterbatch according to different mass fractions to obtain a spinning melt with a solid content of graphene quantum dot in a range of 0.1% to 1%, and then drying in a vacuum oven at a temperature of 60° C. to 100° C. for 6 h to 10 h to obtain the filler for the subsequent spinning; and
step 10, using a twin screw extruder and a winder as equipment for the spinning, adding a resultant mixture obtained in the step 8 to the twin screw extruder, switching a tap position of the twin screw extruder to a mixing tap position before the spinning, and blending the resultant mixture in the twin screw extruder at a rotational speed of 30 rpm to 40 rpm for 5 min to 10 min; and then switching the tap position of the twin screw extruder to an extrusion tap position, adding the filler, adjusting the rotational speed to 10 rpm to 20 rpm, and perform the spinning; wherein a heating temperature setting of the twin screw extruder is as follows: a first zone is at 180° ° C. to 200° C., a second zone is at 200° ° C. to 220° C., and a third zone is at 180° C. to 220° C.; and a winding speed of the winder is in a range of 80 meters per minute (m/min) to 120 m/min.

8. The preparation method for the graphene quantum dot/polymer antibacterial and antiviral composite fiber according to claim 7, wherein the organic solvent is xylene and a mass fraction ratio of the polymer masterbatch to the xylene is 1:1-10.

9. A preparation method for graphene quantum dot/polymer antibacterial and antiviral composite fiber, comprising:
preparing a mixture and a filler, wherein the mixture comprises graphene quantum dots and a polymer prepared from a polymer masterbatch, the filler comprises the graphene quantum dots, the polymer and the polymer masterbatch, and a solid content of the graphene quantum dots in the filler is in a range of 0.1% to 1%; and
melt spinning using the mixture and the filler.

10. The preparation method for graphene quantum dot/polymer antibacterial and antiviral composite fiber according to claim 9, wherein a size of each of the graphene quantum dots is in a range of 10 nm to 8000 nm; the polymer masterbatch is one or more selected from the group consisting of a polyamide masterbatch, a polyester masterbatch, and a polyacrylonitrile masterbatch; and a diameter of the graphene quantum dot/polymer antibacterial and antiviral composite fiber is in a range of 20 μm to 500 μm.
